(19) United States
(12) Patent Application Publication
(10) Pub. No.: US 2008/0195830 A1
(43) Pub. Date: Aug. 14, 2008

(54) MEMORY CARDS AND SYSTEMS USING HOST IDENTIFICATION INFORMATION FOR DATA SECURITY AND METHODS OF OPERATING

(75) Inventors: Bong-Ryeol Lee, Seoul (KR); Eun-Jin Choi, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/022,798

(22) Filed: Jan. 30, 2008

(30) Foreign Application Priority Data
Feb. 8, 2007 (KR) 10-2007-13354

(51) Int. Cl. G06F 12/00

(52) U.S. Cl. 711/164; 711/E12.001

(57) ABSTRACT

A memory card can include a memory that is configured to store data and a memory controller that is configured to store host identification information and a password. The memory controller can be configured to control read/write access to the memory, where the memory controller can allow a host read and/or write access to the memory upon determining that the host identification information stored by the memory controller corresponds to the host.

### CROSS-REFERENCE TO RELATED APPLICATIONS

This U.S. non-provisional patent application claims priority under 35 U.S.C. § 119 of Korean Patent Application No. 2007-13354, filed on Feb. 8, 2007, the entire contents of which are hereby incorporated by reference.

### FIELD OF THE INVENTION

The invention relates to the field of electronics, and more particularly, to memory cards and methods of operating.

### BACKGROUND

Recently, memory cards such as a Secure Digital (SD) card, a Multi-Media Card (MMC), an eXtreme Digital (xD) card, a Compact Flash (CF) card, and a memory stick are widely used in the market. These types of memory cards may be widely used in various hosts. Hosts using the memory card include personal computers (PCs), notebook computers, mobile phones, MP3 players, Portable Media Players (PMPs), and digital cameras, and the like.

FIG. 1 is a view of an external appearance/form-factor of a memory card. In particular, FIG. 1 illustrates an SD card having nine pins. A conventional SD card can include four data pins (pin numbers 1, 7, 8, and 9), one command pin (pin number 2), one clock pin (pin number 5), and three power source pins (pin numbers 3, 4, and 6). The SD card can transmit a command and a response signal into a host through the command pin (pin number 2). Here, the command is transmitted from the host to the SD card, and the response signal is transmitted from the SD card to the host.

The memory card such as the SD card can be used for a portable storage device, and for personal purposes. Devices currently on the market may allow another person access to the memory card without any restrictions. The SD card or the MMC supports lock and unlock functions, but these functions may be usable in a very limited host. When the lock function is set up in the memory card, read and write operations of the memory card may be disabled. When the memory card is unlocked, read and write operations are possible.

Since the size of the memory card is relatively small and can be easily transported, the memory card can be easily lost. If the memory card is locked when lost, there may be no security problem. However, if the memory card is not locked when lost, the data may be easily accessed.

To help avoid this situation, the memory card may request a password each time being accessed. When the memory card has a password function, personal information contents may be safe when lost. However, when the memory card requests a password from all hosts, a password input process may be cumbersome for a user, as the memory card may be mainly used for personal devices, such as computers and digital cameras.

### SUMMARY

Embodiments according to the invention can provide memory cards and systems using host identification information for data security, and methods of operating the same. Pursuant to these embodiments, a memory card can include a memory configured to store data and a memory controller that is configured to store host identification information and a password. The memory controller can also be configured to control read/write access to the memory, where the memory controller is further configured to allow a host read and/or write access to the memory upon determining that the host identification information stored by the memory controller corresponds to the host.

In some embodiments according to the invention, a memory card system includes a host, such as a personal computer, MP3 player, digital camera, or the like and a memory card that can include a memory controller that is configured to store host identification information and a password. The memory controller can be further configured to control read/write access to the memory, and to allow a host read and/or write access to the memory upon determining that the host identification information stored by the memory controller corresponds to the host.

In some embodiments according to the invention, a method of operating a memory card can include receiving host identification information corresponding to a host, determining whether the host identification information matches host identification information stored by the memory card, allowing access to data stored by the memory card without requesting input of a password from the host when the host identification information matches, and requesting a password input from the host when the host identification information does not match the host identification information stored by the memory card, and allowing access the data when the password input provided from the host matches the password stored by the memory card.

### BRIEF DESCRIPTION OF THE DRAWINGS

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view of an external appearance of a memory card;

FIG. 2 is a block diagram of the illustrates memory cards in some embodiments according to the invention;

FIG. 3 is a flowchart illustrating operations of memory cards in some embodiments according to the invention, such as password setting a memory card of FIG. 2; and

FIG. 4 is a flowchart illustrating operations of memory cards in some embodiments according to the invention, such as host identification information and password identification of FIG. 2.

### DESCRIPTION OF EMBODIMENTS ACCORDING TO THE INVENTION

The invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or connected to the other element or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “form-factor” means the physical size and shape of the memory card. Moreover, the form-factor of memory cards according to some embodiments of the invention corresponds to a Multi-Media Card (MMC), a Secure Digital memory card, an eXtreme Digital (xD) card, a Compact Flash (CF) card or the like, that has a size and shape that allows such memory cards to be used with other compliant devices and hosts (such as general purpose personal computers).

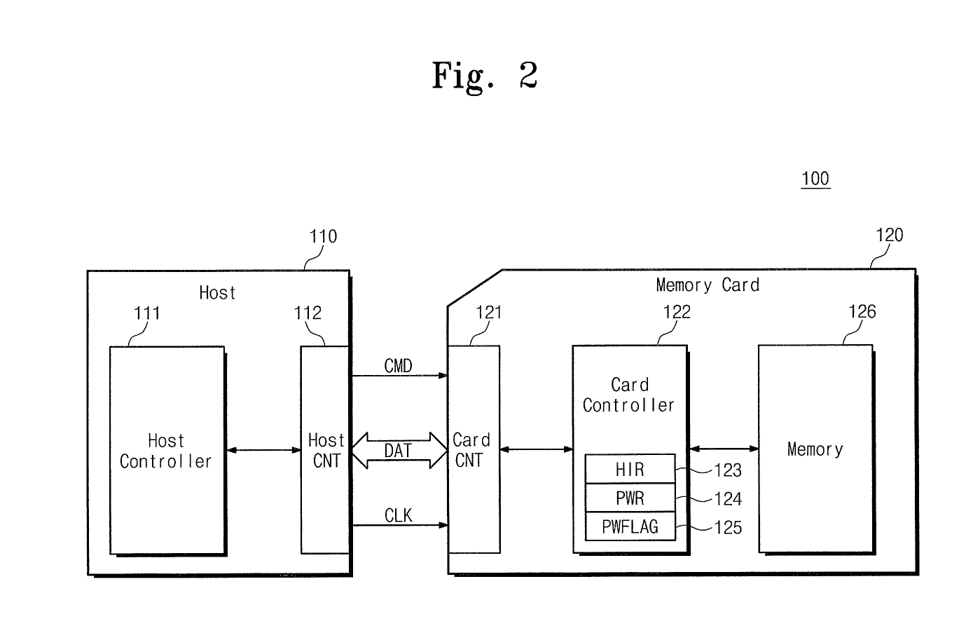

FIG. 2 is a block diagram of a memory card system according to the present invention. Referring to FIG. 2, a memory card system 100 includes a host 110 and a memory card 120. The host 110 includes a host controller 111 and a host connection unit 112. The host 110 includes all kinds of electric devices to which the memory card 120 can be connected or mounted. For example, the host 110 includes a personal computer (PC), a notebook computer, a mobile phone, an MP3 player, a portable media player (PMP), and a digital camera. The host using the memory card mainly is a personal electronic device.

The memory card 120 includes a card connection unit 121, a card controller 122, and a memory 126. The widely used memory card 120 includes a Secure Digital (SD) card, a Multi-Media Card (MMC), an eXtreme Digital (xD) card, a Compact Flash (CF) card, and a memory stick.

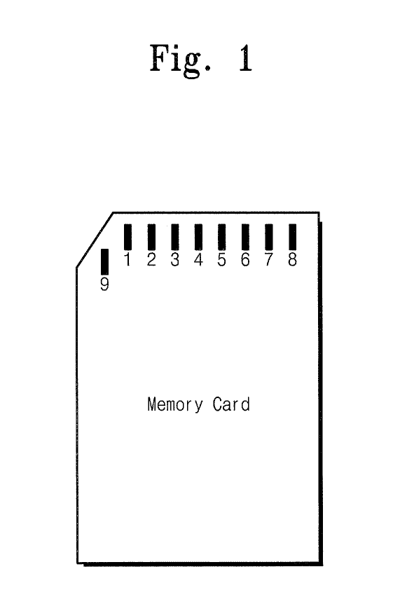

The host 110 and the memory card 120 are connected through a plurality of pins. The host connection unit 112 and the card connection unit 121 are electrically connected to the host 110 and the memory card 120, respectively, through a plurality of pins. The plurality of pins includes a command pin, a data pin, a clock pin, a power source pin, etc. The number of pins varies according to the kind of the memory card 120. For example, The SC card of FIG. 1 includes nine pins.

The host 110 writes data in the memory card 120 or read data stored in the memory card 120. For example, a digital camera stores pictures and movies in the SD card or reads pictures and movies stored in the SD card. The host controller 111 generates a command (CMD) and a clock signal (CLK) for a data reading or writing operation. Moreover, the host controller 111 is synchronized with the clock signal CLK to transmit data DAT into the memory card 120 through the host connection unit 112.

The card controller 122 receives the command CMD and the clock signal CLK through the card connection unit 121, and controls general operations of the memory card 120. The card controller 122 stores data in the memory 126 in response to a write command or reads data from the memory 126 in response to a read command.

On the other hand, the memory card 120 may request a password from the host 110 to protect data when the memory card 120 is connected to the host 110. When the memory card 120 has a password function, personal secret information can be protected from another person when lost. However, when memory card 120 requests passwords from all the hosts 100, a user may be cumbersome due to frequent password inputs. The reason is that the memory card 120 is mainly used for an electric device such as a person computer or a digital camera. As appreciated by the present inventors, when the memory card 120 is used with a personal host (i.e., a host which is used frequently to access the memory card 120), inconvenience of frequently inputting passwords needs to be resolved.

The memory card 120 of the present invention includes a host information register 123, a password register 124, and a flag register 125 in the memory card 120 to resolve the above inconvenience. Theses registers are included in the card controller 122 in FIG. 2, but may be separated from the card controller 122.

The host information register 123 stores host identification information Host_ID. Here, the host identification information Host_ID is about a specific host that a user mainly uses. When the memory card 120 is connected to a specific host, an additional password input process is omitted, thereby resolving the inconvenience due to a frequent password input.

It will be understood that in some embodiments of the invention, the host identification information can be configured to uniquely match the host identification information stored by the memory controller. In other embodiments according to the invention, the host identification information provided by the host may only correspond to the host. For example, the memory card may subject to the host identification information provided by the host to further processing in order to transform the host identification information provided to the memory card so that it may be compared to the host identification information stored by the memory controller. Accordingly, the host identification information provided by the host and the host identification information stored by the memory controller need only corresponds one another so that the host identification information uniquely identifies the host. Similarly, the password may be also transformed by the memory card once received from the host.

It will also be understood that although some embodiments according to the invention are described herein as having the memory controller store host identification information and passwords, in some embodiments according to the invention, the memory controller may actually only control how the host identification information in passwords are stored. In other words, the host identification information and passwords may actually be stored outside the memory controller, and not internal to the memory controller.

The password register 124 stores a password PW. The password register 124 stores a password PW or a secrete number, which is set by a user. When the memory card 120 is connected to an unspecified host that a user does not use, a password confirming process is performed. That is, the memory card 120 operates only if a password that a user inputs is identical to a password stored in the password register PWR. This will protect data in an unspecific host of another person through a password confirming process.

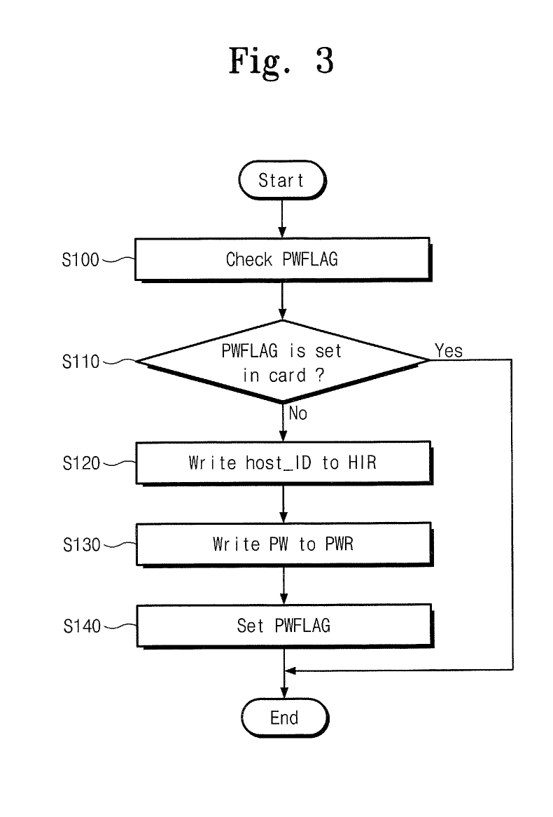

The flag register PWFLAG 125 stores a flag signal determining whether the password PW is set up in the memory card 120 or not. When the memory card 120 is connected to the host 110, it confirms whether the flag signal is stored in the flag register 125 or not. When the flag signal is not set up, the memory card 120 performs a password setting operation first. The password setting operation will be described in more detail with reference to FIG. 3.

FIG. 3 is a flowchart illustrating a password setting method of a memory card of FIG. 2. Referring to FIGS. 2 and 3, a method of setting a password in the memory card 120 will be described.

In operation S100, the host 110 checks a password flag PWFLAG. Whether the password PW is set up or not is stored in the flag register 125 of the memory card 120. For example, when the password PW is set in the memory card 120, data 1 is stored in the flag register 125 and when the password PW is not set in the memory card 120, data 0 is stored in the flag register 125.

In operation S110, when there is a password in the memory card 120, a password setting operation is terminated. This is a case of when the data 1 is stored in the flag register 125 in operation S100. When the password is not set up in the memory card 120, the password setting operation is performed in operations S120 to 140.

In operation S120, the memory card 120 recodes the host identification information Host_ID in the host information register HIR. The host 110 provides a host identification information write command into the memory card 120. The host 110 provides the host identification information Host_ID to the memory card 120. The memory card 120 sends a response signal to the host 110, and records the host identification information Host_ID in the host information register HIR.

In operation S130, the memory card 120 records the password PW in the password register PWR. The host 110 provides the password write command WPWR to the memory card 120. The host 110 provides the password PW to the memory card 120. The memory card 120 sends a response signal to the host 110, and records the password PW in the password register PWR.

In operations S120 and 130, the host identification information write command WHIR, the password write command WPWR, and the response signal are transmitted through the command line CMD of FIG. 2. The host identification information Host_ID and the password PW are transmitted through a data line DAT. Here, the host identification information Host_ID and the password PW can be transmitted through the command line CMD besides the data line DAT.

In operation S140, the memory card 120 stores the password PW in the password register PWR, and then sets the password flag PWFLAG. The memory card 120 sets the password flag PWFLAG in the flag register 125. That is, in the above example, the flag register 125 stores the data 1 as the password flag signal. Hereinafter, it is assumed that the memory card 120 stores the password PW.

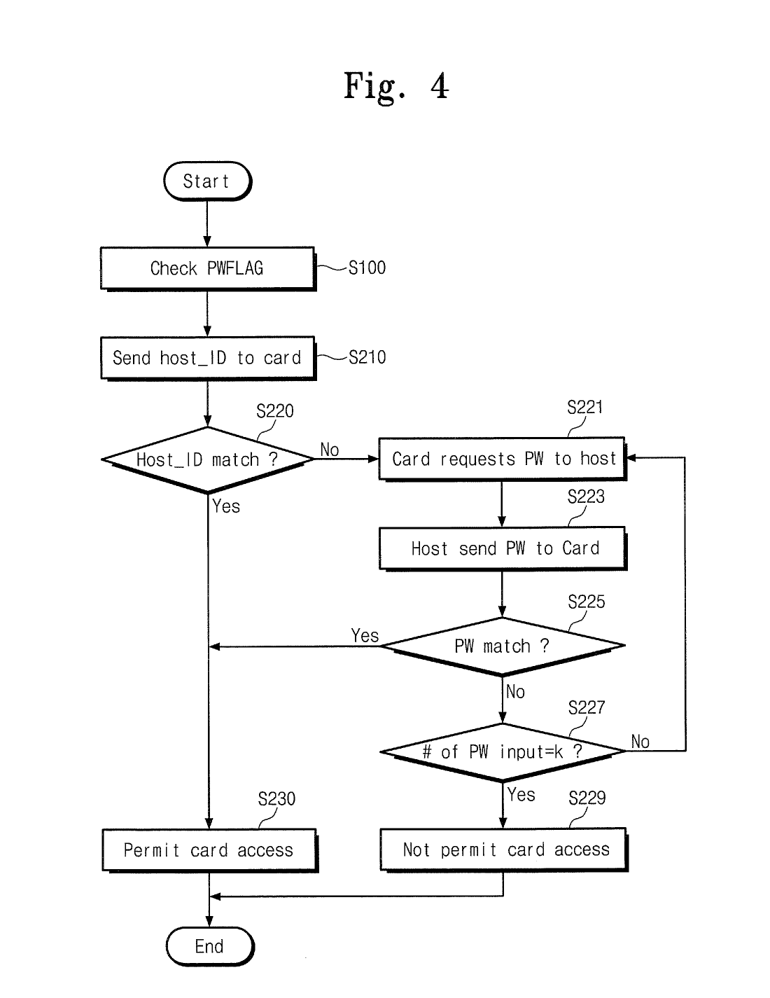

FIG. 4 is a flowchart illustrating a host identification information and password identification method in a memory card of FIG. 2.

In operation S100, when the memory card 120 is connected to the host 110, the host checks the password flag PWFLAG first. Since the password PW is set up in the memory card 120, data 1 is stored in the flag register 125.

In operation S210, the host 110 provides the host identification information Host_ID to the memory card 120. The memory card 120 compares the host identification information Host_ID provided from the host 110 to the host identification information Host_ID stored in the host information register 123.

In operation S220, it is determined whether two host identification information Host_ID are identical or not. When the host identification information is identical, the memory card 120 allows a card access in operation S230. The memory card 120 of the present invention stores the host identification information Host_ID for personally-used electronic devices in advance, and allows an instant access without going through an additional password input process. According to the present invention, each time the memory card 120 accesses the personally-used electronic devices, inconvenience of frequent password inputs needs to be resolved.

When the host identification information Host_ID is not identical in operation S220, the memory card 120 performs an additional password confirming process. First, the memory card 120 requests the password PW from the host 110 in operation S221. In operation S223, the host 110 provides the password PW to the memory card 120 in response to the request.

Next, the memory card 120 determines whether the password PW is identical or not. That is, the memory card 120 compares the password provided from the host 110 to the password stored in the password register 124 for determining the sameness. When the password PW is identical, the memory card allows a card access in operation S230.

When the password PW is not identical in operation S225, the memory card 120 examines the number of password inputs. If the number of password inputs is less than k (k is a natural number), operations S221 to 225 repeats. If the number of password inputs is more than k, the memory card 120 denies a card access in operation S229.

The memory card 120 of the present invention operates in a frequently used electronic device without a password confirming process, and operates in a general electronic device with a password confirming process. According to the present invention, the security of the memory card 120 can be protected and the inconvenience due to frequent password inputs can be resolved.

The memory card of the present invention operates in a specific host without a password confirming process, and operates in an unspecified host with a password confirming process. According to the present invention, the security of the memory card can be protected and the inconvenience due to frequent password inputs can be resolved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. A memory card comprising:
a memory configured to store data; and
a memory controller configured to store host identification information and a password and configured to control read/write access to the memory,
wherein the memory controller is further configured to allow a host read and/or write access to the memory upon determining that the host identification information stored by the memory controller corresponds to the host.

2. The memory card of claim 1, wherein the memory controller is further configured to compare host information provided by the host to the host information stored by the memory controller to determine whether the host identification information stored by the memory controller corresponds to the host.

3. The memory card of claim 1, wherein the memory controller is further configured to request password input from the host when the host identification information is not identical.

4. The memory card of claim 1, wherein the memory controller comprises:
a host information register configured to store the host identification information stored by the memory controller; and
a password register configured to store the password stored by the memory controller.

5. The memory card of claim 4, wherein the memory controller further comprises:
a flag register configured to indicate whether password input provided by the host corresponds to the password stored by the memory controller.

6. The memory card of claim 5, wherein the memory controller stores the host identification information in the host information register when the flag signal is not set up in the flag register, and sets up the flag signal by storing the password in the password register.

7. The memory card of claim 1, wherein the memory card comprises a form-factor compliant SD card and/or MMC.

8. The memory card of claim 1, wherein the memory card receives the host identification information or the password from the host via a command pin of the memory card.

9. The memory card of claim 1, wherein the memory card receives the host identification information or the password from the host via a data pin of the memory card.

10. A memory card system comprising:
a host; and
a memory card including a memory controller configured to store host identification information and a password and configured to control read/write access to the memory, wherein the memory controller is further configured to allow a host read and/or write access to the memory upon determining that the host identification information stored by the memory controller corresponds to the host.

11. The memory card system of claim 10 wherein the memory controller is further configured to compare host information provided by the host to the host information stored by the memory controller to determine whether the host identification information stored by the memory controller corresponds to the host.

12. The memory card system of claim 10, wherein the memory controller is further configured to request password input from the host when the host identification information is not identical.

13. The memory card system of claim 10, wherein the memory card comprises:
a host information register configured to store the host identification information stored by the memory controller; and
a password register configured to store the password stored by the memory controller.

14. The memory card system of claim 13, wherein the memory card further comprises:
a flag register configured to indicate whether password input provided by the host corresponds to the password stored by the memory controller.

15. The memory card system of claim 14, wherein the memory card stores the host identification information in the host information register when the flag signal is not set up in the flag register, and sets up the flag signal by storing the password in the password register.

16. The memory card system of claim 10, wherein the memory card comprises a form-factor compliant SD card and/or MMC.

17. A method of operating a memory card comprising:
receiving host identification information corresponding to a host;
determining whether the host identification information matches host identification information stored by the memory card;
allowing access to data stored by the memory card without requesting input of a password from the host when the host identification information matches, and requesting a password input from the host when the host identification information does not match the host identification information stored by the memory card; and
allowing access the data when the password input provided from the host matches the password stored by the memory card.

18. The method of claim 17, further comprising confirming whether a flag signal is set up in the flag register or not before the receiving of the host identification information from the host,
wherein the memory controller comprises a flag register storing the flag signal that represents whether the password is stored or not.

19. The method of claim 18, further comprising storing the host identification information and the password in the memory controller when the flag signal is not set up in the flag register.

20. The method of claim 19, wherein the memory controller comprises a host information register storing the host identification information and a password register storing the password.
